(19) United States
(12) Patent Application Publication
(10) Pub. No.: US 2002/0175055 A1
(43) Pub. Date: Nov. 28, 2002

(54) Grooved flexible conveyor belt

(76) Inventor: Ronald Fredrick Ryde, Okanagan Falls (CA)

Correspondence Address: ANTONY C. EDWARDS, SUITE 800, 1708 DOLPHIN AVENUE, KELOWNA, BC, V1Y 9S4, CA

(21) Appl. No.: 10/141,169

(22) Filed: May 9, 2002

Related U.S. Application Data
(60) Provisional application No. 60/290,387, filed on May 14, 2001.

(30) Foreign Application Priority Data
Nov. 21, 2001 (CA) 2,363,480

(51) Int. Cl. B65G 15/42; B65G 15/34

(52) U.S. Cl. 198/847; 198/699; 198/690.2

(57) ABSTRACT

A conveyor belt is mountable to a supporting frame. The belt is actuable in a first longitudinal direction for endless rotation of the belt relative to the frame. The belt includes a resilient endless core, and, mounted on the core, a contiguous endless outer surface and an opposite contiguous endless inner surface, where the outer and inner surfaces are disposed oppositely on the core. Generally laterally extending grooves are formed in the outer surface in a longitudinally spaced array along the belt.

### CROSS REFERENCE TO RELATED APPLICATION

This application claims priority from U.S. Provisional Patent Application No. 60/290,387 filed May 14, 2001 and Canadian Patent Application No. 2,363,480 filed Nov. 21, 2001 entitled Grooved Flexible Conveyor Belt.

### FIELD OF THE INVENTION

This invention relates a grooved, flexible conveyor belt for transporting a large volume of particulate or granular material.

### BACKGROUND OF THE INVENTION

Flexible conveyor belts utilized for the transportation of particulate or granular materials, such as potash, coal, wood chips or grain may have cleats or like projections molded to the upper surface which inhibits rearward slippage of the material when being transported upwardly along an inclined section. Such particulate are prone to slippage especially when wet. Raised or protruding cleats or the like are prone to tear or wear off resulting in inefficient transportation along inclined sections of the conveyor. Standard conveyor belts otherwise have a smooth upper surface allowing rearward downhill slippage of the particulate material.

Conveyor belts having cleats affixed to the upper surface are plagued with numerous operational problems. For example, they are impractical to clean with conventional belt scraping equipment. The snub pulleys on the lower, return side of the conveyor system cause structural damage and excessive wear to both cleats and belt. They cause excessive belt bounce and vibration of the conveyor belt when traveling on the lower return side of the conveyor, resulting in an unacceptable level of noise and concentration of airborne particulates, for example dust, all of which may be harmful to workers. In addition, dust from raised cleat conveyor belts settles on beams etc, in large plants such as grain elevators, pulp mills, and coal plants. This has caused explosions and fires resulting in injuries and some cases death.

Without intending to be limiting, it is therefore an object of this invention to provide a flexible conveyor belt which is readily usable on existing conveyor systems and which is relatively easy to clean with conventional belt scraping equipment. Again without intending to be limiting, it is a further object of this invention to provide a flexible conveyor belt having grooves formed in the upper surface which is, therefore, without projecting features, resulting in a longer life and reduced maintenance.

### SUMMARY OF THE INVENTION

The conveyor belt of the present invention is a flexible rubber belt generally of between 12 to 120 inches (0.3 to 3 m) in width and manufactured in several layers, which are securely bonded together. Such belts generally comprise a first or lower layer which protects the belt from wear as it passes over rollers and supporting structures of the conveyor; a second intermediate layer often contains reinforcing materials such as either layers of nylon fabric or steel cables or the like which provide strength and dimensional stability; and a top layer manufactured of a durable rubber compound of at least ¼ inch (6.4 mm) in thickness.

The top layer of the flexible rubber conveyor belt has a longitudinal array of spaced apart grooves, channels or recesses (collectively referred herein as “grooves”) formed in it. Typically, by way of example, such grooves may be 3/16 inch deep (5 mm) and ⅝ inch wide (16 mm) and are generally spaced 4 inches (100 mm) apart along the length of the conveyor belt. However, such spacing can vary to suit the type of particulate material being handled and the degree of inclination of the inclined slope of the conveyor. The grooves may be molded or cut into almost all rubber covered conveyor belts such as oil resistant, chemical resistant, standard RMAI, fire resistant, high temp, low temp, abrasion resistant belts and many more.

Such spaced apart grooves can take the form of a variety of patterns. For example, a groove may be a single chevron extending across the conveyor belt with the arms of the chevron generally extending toward the direction of travel. Conveyor belts may have different patterns by angling the arms of the chevron to include either an obtuse angle, an acute angle or an angle of 90 degrees. The grooves or recesses may also form a pattern comprising several or a plurality of small chevrons extending transversely across the conveyor. Further, patterns may be achieved by using arcuate shaped grooves of various radii.

The grooved, flexible conveyor belt for transporting particulate or granular material is generally self cleaning as it passes around the head roller thus substantially reducing the amount of airborne particulates as it travels on the lower return side of the conveyor. In addition, the skirting at the loading area can be placed in proximity to the conveyor belt which is not practicable when conveyor belts with raised cleats are in use.

In summary, the conveyor belt of the present invention is mountable to a supporting frame and actuable in a first longitudinal direction for endless rotation of the belt relative to the frame about spaced apart rotational supports rotatably mounted on the frame. The belt includes a resilient endless core, and, mounted on the core, a contiguous endless outer surface and an opposite contiguous endless inner surface, where the outer and inner surfaces are disposed oppositely on the core.

Generally laterally extending grooves or channels or recesses (again, collectively “grooves” as used herein) are formed in the outer surface in a longitudinally spaced array along the belt. The grooves or channels extend generally laterally across the outer surface between opposite longitudinal edges of the outer surface in longitudinally spaced apart array along the length of the entire belt.

The grooves are adapted to resiliently deform when the belt is mounted on the frame, and when so mounted to rotate endlessly about the rotational supports. During such deformation the grooves radially diverge the groove's longitudinally spaced apart, opposed-facing walls as the belt rotates about the rotational supports.

The grooves may be non-linear, for example the grooves may each have oppositely laterally disposed first and second ends, wherein the first and second ends are generally equally offset, longitudinally along the outer surface, relative to a medial position along each of the grooves. In particular, in some embodiments of the invention, the first and second ends of the grooves are offset in a first longitudinal direction relative to a middle portion of each of the grooves on the belt so that the grooves diverge in the plane of the outer surface in the direction of translation of the belt so as to capture particulate material when the belt is translating along an upward inclination. The first and second ends of the grooves may terminate short of the edges of the belt so as to leave non-grooved longitudinally extending margins on each side of the belt over which may slide skirting rubber mounted to the frame for dust control.

The grooves are formed in the outer surface symmetrically about a medial longitudinal axis of the belt so as to extend equally on either side of the axis. The opposite ends of the grooves are set back from longitudinally extending edges of the belt so as to form the non-grooved margins on the outer surface along the longitudinally extending edges. The margins are sized to slide under overlaying skirting mounted to the frame so that the opposite ends of the grooves do not slide under the skirting.

In some embodiments the grooves are chevron-shaped. In other embodiments the grooves are arcuate, for example so as to follow a generally semi-circular arc.

The grooves may also be formed as a laterally spaced array of a plurality of the grooves spaced laterally across the outer surface of the belt.

### BRIEF DESCRIPTION OF THE DRAWINGS

FIG. 1 is an isometric view of the end of a conveyor belt of the present invention.

FIG. 1a is an enlarged view of a portion of FIG. 1 showing partially cutaway skirting on the belt.

FIG. 2 is a sectional view taken along line 2-2 of FIG. 1.

FIG. 2a is a partial side view of the conveyor belt of the present invention as it passes over the head roller.

FIG. 3 is an enlarged view of the groove and conveyor belt containing particulate material therein.

FIG. 4 is a plan view of a portion of the conveyor belt illustrating one form of grooved pattern.

FIG. 5 is a plan view of a portion of the conveyor belt illustrating an alternative form of grooved pattern.

FIG. 6 is a plan view of a portion of the conveyor belt illustrating a further alternative form of grooved pattern.

FIG. 7 is a plan view of a portion of the conveyor belt illustrating a further alternative form of grooved pattern.

FIG. 8 is a plan view of a portion of the conveyor belt illustrating an alternative form of grooved pattern.

FIG. 9 is a plan view of a portion of the conveyor belt illustrating a further alternative form of grooved pattern.

FIG. 10 is a plan view of a portion of the conveyor belt illustrating an alternative form of grooved pattern.

### DETAILED DESCRIPTION OF EMBODIMENTS OF THE INVENTION

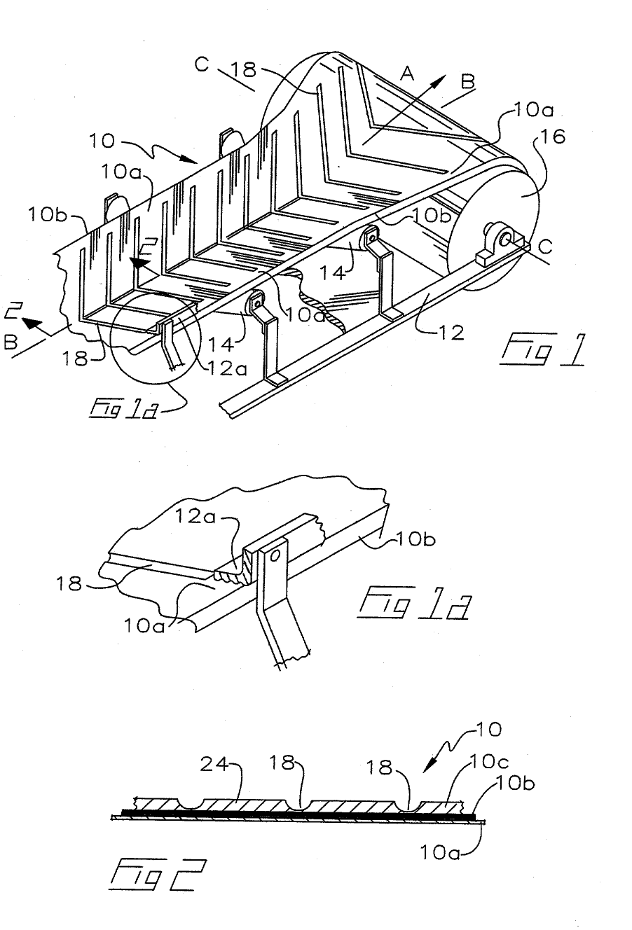

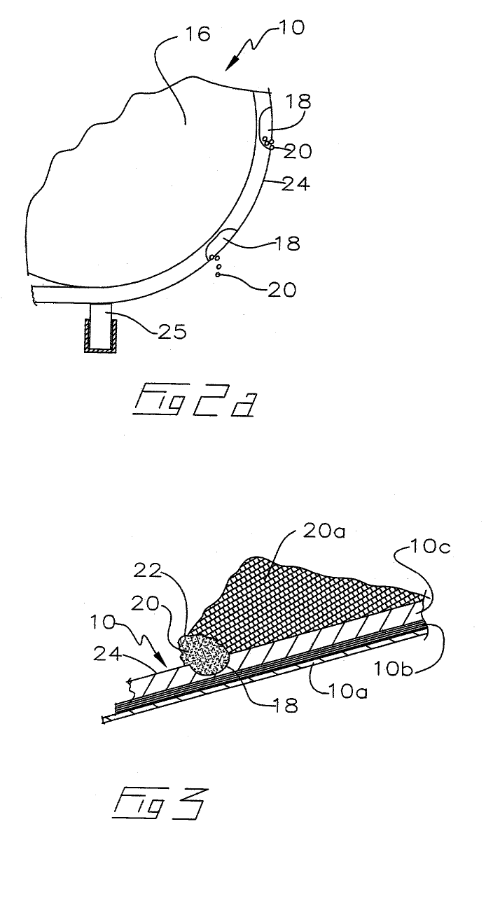

With reference to the drawing figures wherein similar characters of reference denote corresponding parts in each view, the grooved, flexible endless conveyor belt 10 of FIG. 1 may be manufactured in several layers 10a, 10b and 10c respectively as seen in FIGS. 2 and 3. The layers are securely bonded together as would be known to one skilled in the art. A lower layer 10a is manufactured specifically to resist wear, an intermediate layer with reinforcing materials embedded therein to provide tensile and shear strength and dimensional stability to the belt and an upper layer of a durable resilient compound such as rubber. The belt may be made of material to reduce or inhibit static attraction between the belt and the particulate material being carried.

Conveyor belt 10 may be supported on a frame 12 having intermediate supporting rollers 14 and one or more drive rollers 16 for rotation about the end-most rollers in direction of travel A.

Upper layer 10c of belt 10 has grooves 18 formed therein, which can be formed in a variety of patterns. Such patterns may be adapted to be specific to the particulate material being moved by the conveyor. Grooves 18 may generally extend from adjacent one longitudinal edge of conveyor belt 10, across the belt so as to terminate adjacent the opposite longitudinal edge and may be symmetric about a medial longitudinal axis B of the belt. Such grooves are spaced apart along the longitudinal length of the belt. As better seen in FIG. 1a, where skirting rubber 12a is employed, for dust control or the like, the grooves end short of, so as to form margins 10a along, the edges 10b of the belt. The grooves need only extend across the central load-bearing portion of the belt, and advantageously do not extend beneath the skirting.

In some instances, vibrations within the moving conveyor belt 10 cause fine particles 20 of the material being conveyed to build up within the grooves 18. This creates an upstanding ridge 22 of particles 20 which extends above the upper surface 24 of upper layer 10c. As conveyor belt 10 travels along an incline, larger particulate material 20a collects in front of ridge 22 and is thereby transported along with the conveyor up the incline. In many instances, the larger particulate material 20a or a combination of both small and large fines accumulate in the grooves to form a ridge, the ridge in a sense acting like a virtual cleat.

Conveyor belt 10 is self-cleaning as may be seen in FIG. 2a. As conveyor belt 10 passes around roller 16, upper layer 10c is stretched slightly, which radially outwardly opens grooves 18 thereby permitting the fine particulate material 20 to fall from grooves 18. Such self-cleaning of the conveyor belt by reason of the radial deformation of grooves 18 (radial in the sense of a radial deformation about an axis of rotation C of the head roller 16) reduces the amount of particulate material carried in the grooves back beneath the conveyor and the amount of clean up required. A linear rubber scraper 25 may be mounted beneath belt 10, for example beneath the axis of rotation C. Scraper 25 may extend perpendicularly across the width of the belt and may be made of rubber which is, for example, 2 inches thick. Scraper 25 is mounted or biased, by means known in the art, into contact with surface 24 so as to clean surface 24. In embodiments where grooves 18 are angled relative to the scraper, scraper 25 will not bounce into and out of grooves 18, but, rather, will scrape smoothly along surface 24.

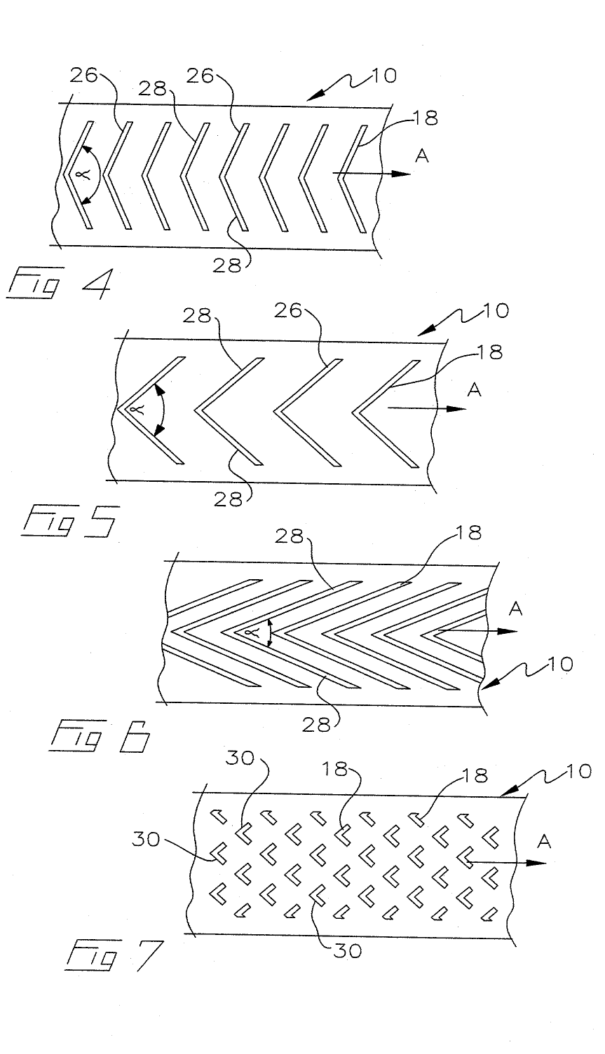

Conveyor belt 10 may have spaced apart grooves or recesses that take the form of a variety of patterns and several such patterns are illustrated by way of example in FIGS. 4 through 8.

FIGS. 4 though 6 illustrate grooves 18 formed as longitudinally spaced arrays of chevrons 26 on conveyor belt 10 with the arms 28 generally inclined and extending in the direction of travel A. Arms 28 may include an angle V which is obtuse as in FIG. 4, generally 90 degrees as seen in FIG. 5 or an acute angle as seen in FIG. 6.

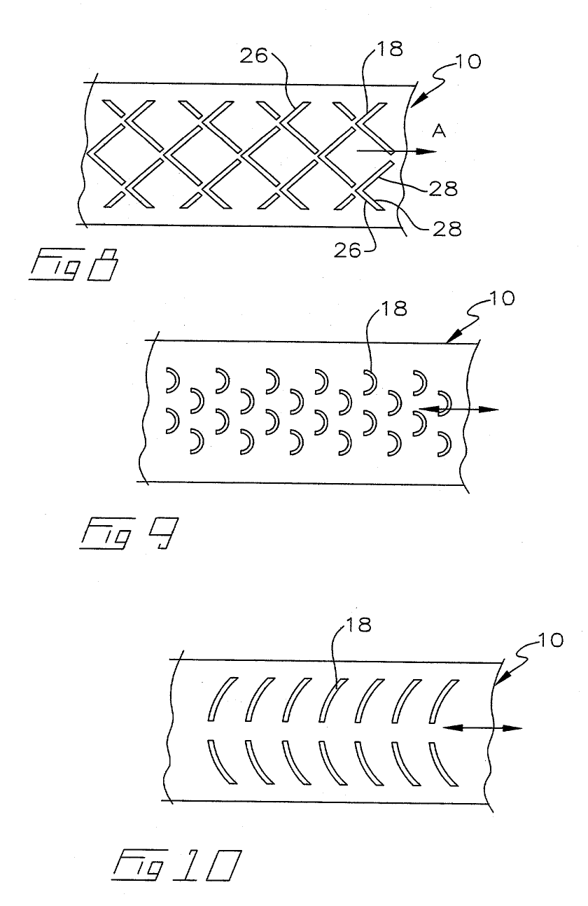

FIG. 7 illustrates a groove pattern of smaller chevrons 30 arranged in rows which extend transversely across the conveyor belt 10. FIG. 8 illustrates a pattern of grooves similar to that illustrated in FIG. 7 but with larger chevrons.

FIGS. 9 and 10 illustrate grooves 18 which are arcuate in shape. Such grooves may be best adapted for conveyors which travel in both a forward and reversed direction.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A conveyor belt mountable to a supporting frame and actuable in a first longitudinal direction for endless rotation of the belt relative to the frame about spaced apart rotational supports rotatably mounted on said frame, the belt comprising:
a) a resilient endless core,
b) a contiguous endless outer surface and an opposite contiguous endless inner surface, said outer and inner surfaces disposed oppositely on said core,
wherein generally laterally extending grooves or channels are formed in said outer surface, said grooves or channels extending generally laterally across said outer surface between opposite longitudinal edges of said outer surface in longitudinally spaced apart array along the length of said belt,
said grooves or channels adapted to resiliently deform, so as to radially diverge longitudinally spaced apart, opposed-facing sidewalls of said grooves or channels, as said belt rotates about said rotational supports when said belt is mounted on said frame, and so mounted to rotate endlessly about said rotational supports.

2. The conveyor belt of claim 1 wherein said grooves or channels are non-linear.

3. The conveyor belt of claim 2 wherein said grooves or channels each have oppositely laterally disposed first and second ends, and wherein said first and second ends are generally equally offset, longitudinally along said outer surface, relative to a medial position along each of said grooves or channels.

4. The conveyor belt of claim 3 wherein said first and second ends of said grooves or channels are offset in said first longitudinal direction relative to said medial position of each said grooves or channels.

5. The conveyor belt of claim 4 wherein said grooves or channels are chevron-shaped.

6. The conveyor belt of claim 4 wherein said grooves or channels are arcuate.

7. The conveyor belt of claim 6 wherein said grooves or channels follow a generally semi-circular arc.

8. The conveyor belt of claims 5 or 6 wherein said grooves or channels are symmetrically arranged relative to said opposite longitudinal edges of said outer surface of said belt.

9. The conveyor belt of claim 1 wherein said grooves or channels are also formed as a laterally spaced array of a plurality of said grooves or channels spaced laterally across said outer surface, and wherein said grooves or channels are non-linear.

10. A conveyor belt mountable to a supporting frame and actuable in a first longitudinal direction of travel for endless rotation of the belt relative to the frame about spaced apart rotational supports rotatably mounted on the frame, comprises:
a resilient endless core, and mounted on said core a contiguous endless outer surface and an opposite contiguous endless inner surface, wherein said outer and inner surfaces are disposed oppositely on said core,
a longitudinally spaced apart array of laterally extending grooves formed in said outer surface, wherein said grooves extend generally laterally across said outer surface between opposite longitudinal edges of said outer surface in said longitudinally spaced apart array along the entire length of said belt,
wherein said grooves are adapted to resiliently deform, when said belt is mounted on the frame so as to rotate endlessly about the rotational supports, as said grooves are rounding the rotational supports so that the opposed-facing walls of said grooves diverge as the belt rotates about the rotational supports.

11. The belt of claim 10 wherein said grooves are non-linear.

12. The belt of claim 11 wherein said grooves each have oppositely laterally disposed first and second ends, wherein said first and second ends are generally equally offset, longitudinally along said outer surface, relative to a medial position along each of said grooves.

13. The belt of claim 12 wherein said first and second ends of said grooves are offset in the first longitudinal direction relative to a middle portion of each of said grooves so that said grooves diverge in a plane containing said outer surface in the direction of translation of said belt so as to capture particulate material when said belt is translating along an upward inclination.

14. The belt of claim 13 wherein said grooves are chevron-shaped.

15. The belt of claim 13 wherein said grooves are arcuate.

16. The belt of claim 15 wherein said grooves are semi-circular.

17. The belt of claim 10 wherein said grooves are formed in said outer surface symmetrically about a medial longitudinal axis of said belt so as to extend equally on either side of said axis, and wherein opposite ends of said grooves are set back from longitudinally extending edges of said belt so as to form non-grooved margins on said outer surface along said longitudinally extending edges, said margins sized to slide under overlaying skirting mounted to said frame so that said opposite ends of said grooves do not slide under the skirting.

18. The belt of claim 10 wherein each said groove is formed as a laterally spaced array of a plurality of smaller grooves spaced laterally across said outer surface.
